(19) United States
(12) Patent Application Publication
(10) Pub. No.: US 2013/0278219 A1
(43) Pub. Date: Oct. 24, 2013

(54) Battery Testing System and Control Method for Battery Testing System

(71) Applicants: Fenglong YU, Shanghai (CN); Tao ZHANG, Shanghai (CN)

(72) Inventors: Fenglong YU, Shanghai (CN); Tao ZHANG, Shanghai (CN)

(73) Assignee: O2MICRO, INC., Santa Clara, CA (US)

(21) Appl. No.: 13/460,715

(22) Filed: Apr. 30, 2012

(30) Foreign Application Priority Data
Apr. 20, 2012 (CN) 201210118618.9

(51) Int. Cl. H02J 7/00

(52) U.S. Cl. 320/130; 320/134

(57) ABSTRACT

Embodiments of the invention provide a battery testing system. The battery testing system includes a charger, a discharging unit, and a switch board. The switch board receives a first control signal from the control unit and controls the charger according to the first control signal, receives a first monitoring signal from the charger indicating a charging status of the battery and controls the control unit according to the first monitoring signal, receives a second control signal from the control unit and controls the discharging unit according to the control signal, and receives a second monitoring signal from the discharging unit indicating a discharging status of the battery and controls the control unit according to the second monitoring signal. The control unit is electrically isolated from the discharging unit and the charger by the switch board. Different charging/discharging equipments can be employed to test the battery.

### RELATED APPLICATIONS

This application claims priority to Chinese Patent Application No. 201210118618.9, titled “Battery Testing System and Control Method for Battery Testing System,” filed Apr. 20, 2012, with the State Intellectual Property Office of the People's Republic of China.

### BACKGROUND

A battery is charged and discharged repeatedly during a research and development process such that battery producers can test the battery to obtain the performance of the battery. A cycling battery tester is usually used to charge and discharge the battery repeatedly. FIG. 1 shows a conventional battery testing system 100 which utilizes a cycling battery tester 110 for testing a battery 108. The cycling battery tester 110 includes a discharging module 104, a charging module 106, and a control unit 102. The control unit 102 controls the discharging module 104 and the charging module 106. If the cycling battery tester 110 is in a discharging mode, the discharging module 104 discharges the battery 108. If the cycling battery tester 110 is in a charging mode, the charging module 106 charges the battery 108.

The charging module 106 and the discharging module 104 are fixed in the cycling battery tester 110. Thus, other types of charging or discharging modules may not be used to test the battery 108.

### SUMMARY

Embodiments of the invention provide a battery testing system. The battery testing system includes a charger, a discharging unit, and a switch board. The charger is operable for charging the battery under control of a control unit. The discharging unit is operable for discharging the battery under control of the control unit. The switch board receives a first control signal from the control unit and controls the charger according to the first control signal, receives a first monitoring signal from the charger indicating a charging status of the battery and controls the control unit according to the first monitoring signal, receives a second control signal from the control unit and controls the discharging unit according to the second control signal, and receives a second monitoring signal from the discharging unit indicating a discharging status of the battery and controls the control unit according to the second monitoring signal. The control unit is electrically isolated from the discharging unit and the charger by the switch board. Different charging/discharging equipments can be employed to test the battery.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates an example of a conventional battery testing system.

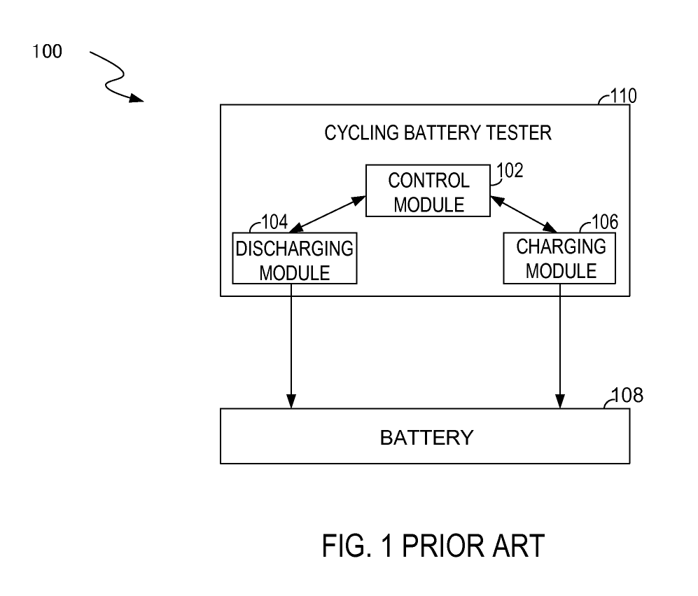

FIG. 2 illustrates an example of a battery testing system, in accordance with one embodiment of the present invention.

FIG. 3 illustrates an example of the discharging unit in FIG. 2, in accordance with one embodiment of the present invention.

FIG. 4 illustrates an example of the switch board in FIG. 2, in accordance with one embodiment of the present invention.

FIG. 5 illustrates an example of a switch board in FIG. 2, in accordance with another embodiment of the present invention.

FIG. 6 illustrates a flowchart of a method for controlling a battery testing system, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

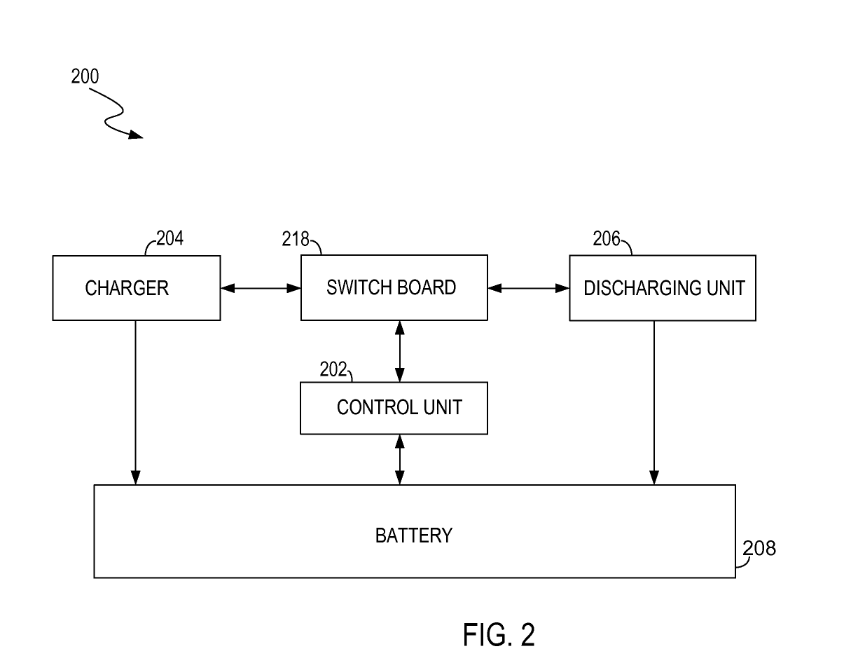

FIG. 2 illustrates an example of a battery testing system 200, in accordance with one embodiment of the present invention. The battery testing system 200 includes a charger 204, a discharging unit 206, and a switch board 218. The charger 204 is operable for charging a battery 208 under control of a control unit 202. The discharging unit 206 is operable for discharging the battery 208 under control of the control unit 202. The switch board 218 receives a first control signal from the control unit 202 and controls the charger 204 according to the first control signal. The switch board 218 receives a first monitoring signal from the charger 204 indicating a charging status of the battery 208 and controls the control unit 202 according to the first monitoring signal. The switch board 218 also receives a second control signal from the control unit 202 and controls the discharging unit 206 according to the second control signal. The switch board 218 also receives a second monitoring signal from the discharging unit 206 indicating a discharging status of the battery 208 and controls the control unit 202 according to the second monitoring signal. The control unit 202 is electrically isolated from the discharging unit 206 and the charger 204 by the switch board 218. In one embodiment, a battery management system (BMS) can be used as the control unit 202. The charger 204 charges the battery 208 when the battery testing system 200 is in a charging mode. In one embodiment, the charger 204 is operable for charging the battery 208 independently if the charger 204 is removed from the battery testing system 200. The discharging unit 206 discharges the battery 208 when the battery testing system 200 is in a discharging mode. In one embodiment, the charger 204 and the discharging unit 206 are enabled alternately.

More specifically, the first control signal has a first state and a second state. The charger 204 is enabled to charge the battery 208 if the first control signal is in the first state, and is disabled from charging the battery 208 if the first control signal is in the second state. The first monitoring signal has a first state and a second state. The first monitoring signal is in the first state if a capacity of the battery 208 is less than a predetermined capacity threshold, and is in the second state if the capacity of the battery 208 is greater than the predetermined capacity threshold. The second control signal has a first state and a second state. The discharging unit 206 is enabled to discharge the battery 208 if the second control signal is in the first state, and is disabled from discharging the battery 208 if the second control signal is in the second state. The second monitoring signal has a first state and a second state. The second monitoring signal is in the first state if a voltage of the battery 208 is greater than a predetermined voltage threshold, and is in the second state if the voltage of the battery 208 is less than the predetermined voltage threshold.

In operation, the charger 204 charges the battery 208 if the control unit 202 generates the first control signal with the first state. The charger 204 switches the first monitoring signal from the first state to the second state if the capacity of the battery 208 increases above the predetermined capacity threshold as the battery 208 is being charged. In response to the first monitoring signal with the second state, the control unit 202 switches the first control signal from the first state to the second state. As a result, the charger 204 is disabled from charging the battery 208.

In one embodiment, the battery testing system 200 is configured to switch from the charging mode to the discharging mode if the capacity of the battery 208 increases above the predetermined capacity threshold. More specifically, the control unit 202 switches the second control signal from the second state to the first state once the control unit 202 switches the first control signal from the first state to the second state. Accordingly, the discharging unit 206 is enabled to discharge the battery 208. The discharging unit 206 switches the second monitoring signal from the first state to the second state if the voltage of the battery 208 decreases below the predetermined voltage threshold. In response to the second monitoring signal with the second state, the control unit 202 switches the second control signal from the first state to the second state. As a result, the discharging unit 206 is disabled from discharging the battery 208.

In one embodiment, the battery testing system 200 is configured to switch from the discharging mode to the charging mode if the voltage of the battery 208 decreases below the predetermined voltage threshold. More specifically, the control unit 202 switches the first control signal from the second state to the first state once the control unit 202 switches the second control signal from the first state to the second state. Then, the next cycle begins and the battery 208 is charged again. Thus, the battery 208 is charged and discharged alternately, in one embodiment. In other words, the charger 204 is disabled from charging the battery 208 based on the first control signal if the discharging unit 206 discharges the battery 208 based on the second control signal, and the discharging unit 206 is disabled from discharging the battery 208 based on the second control signal if the charger 204 charges the battery 208 based on the first control signal.

In an alternative embodiment, the battery testing system 200 is configured to switch from the discharging mode to a static mode if the voltage of the battery 208 decreases below the predetermined voltage threshold, and is configured to switch from the charging mode to the static mode if the capacity of the battery 208 increases above the predetermined capacity threshold. Both of the charger 204 and discharging unit 206 are disabled in the static mode.

Advantageously, the switch board 218 transfers signals between the charger 204 and the control unit 202, transfers signals between the discharging unit 206 and the control unit 202, and electrically isolates the control unit 202 from the discharging unit 206 and the charger 204. Therefore, a removable charging equipment, e.g., the charger 204, and a removable discharging equipment, e.g., the discharging unit 206, can be employed in the battery testing system 200. As such, the battery 208 can be tested by different charging equipments with different charging methods.

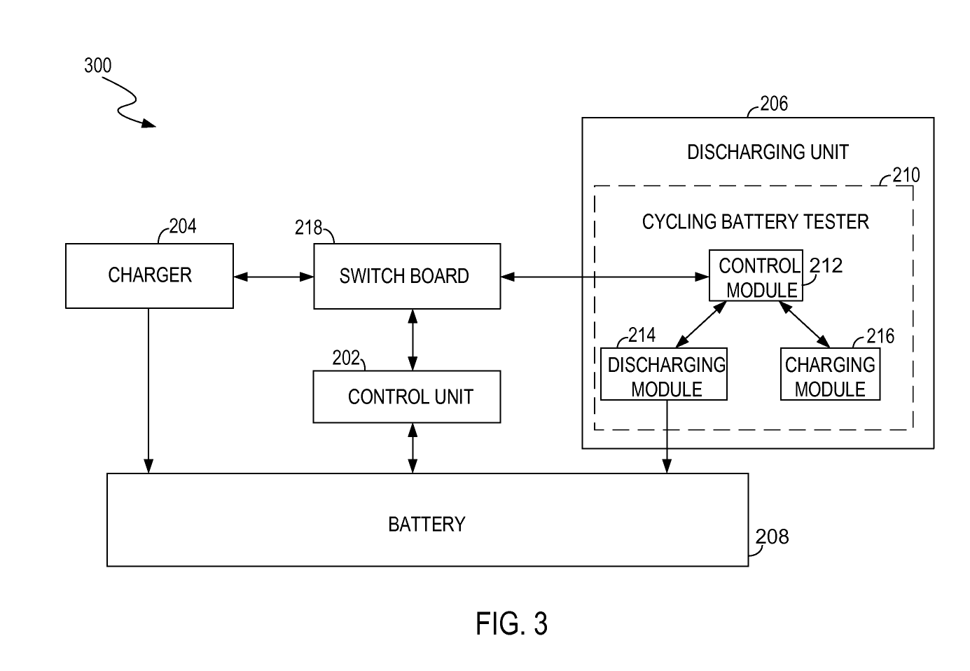

FIG. 3 illustrates an example of a discharging unit 206 in FIG. 2, in accordance with one embodiment of the present invention. In the example of FIG. 3, the discharging unit 206 includes a cycling battery tester 210. The cycling battery tester 210 includes a discharging module 214, a charging module 216, and a control module 212. The control module 212 controls the discharging module 214 and charging module 216. The discharging module 214 discharges the battery 208 when the battery testing system 200 is in the discharging mode. The charger 204 charges the battery 208 if the battery testing system 200 is in the charging mode. The charging module 216 of the cycling battery tester 210 is disabled if the charger 204 is present. If the charger 204 is removed from the battery testing system 200, the battery 208 can be charged by the charging module 216 of the cycling battery tester 210.

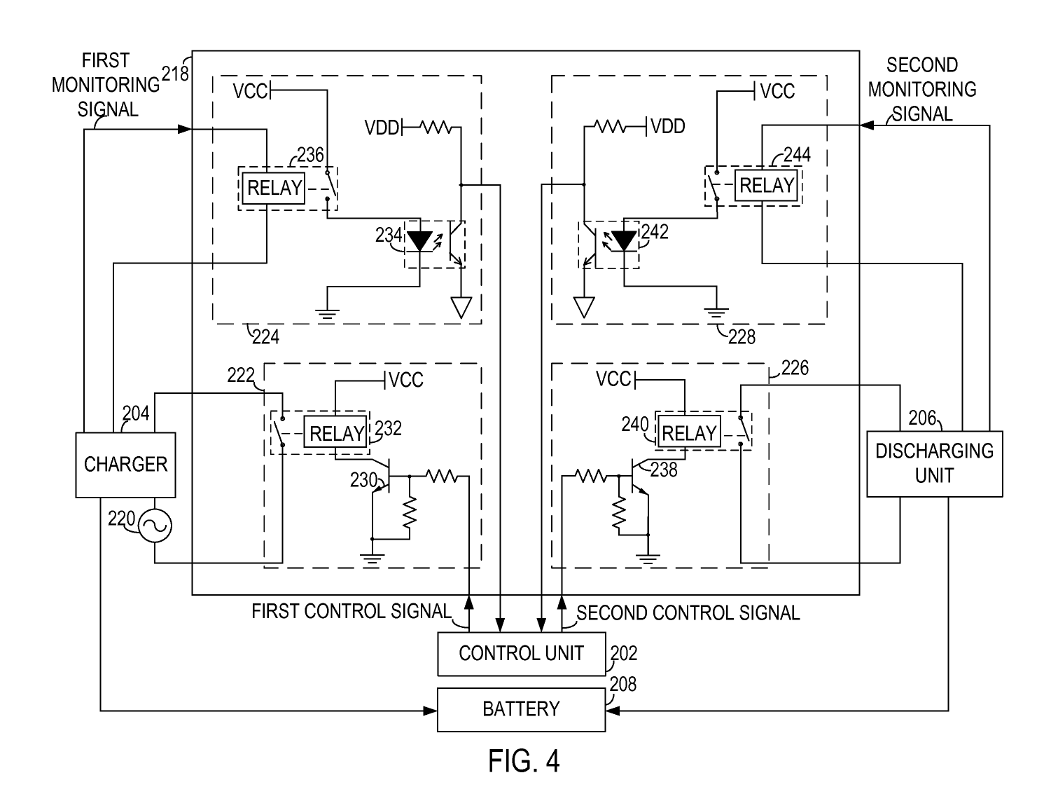

FIG. 4 illustrates an example of a switch board 218 in FIG. 2, in accordance with one embodiment of the present invention. The switch board 218 includes a first switch module 222, a second switch module 224, a third switch module 226, and a fourth switch module 228. The first switch module 222 receives the first control signal from the control unit 202, controls the charger 204 according to the first control signal, and electrically isolates the charger 204 from the control unit 202. The second switch module 224 receives the first monitoring signal from the charger 204 indicating a charging status of the battery 208, controls the control unit 202 according to the first monitoring signal, and electrically isolates the charger 204 from the control unit 202. The third switch module 226 receives the second control signal from the control unit 202, controls the discharging unit 206 according to the second control signal, and electrically isolates the discharging unit 206 from the control unit 202. The fourth switch module 228 receives the second monitoring signal from the discharging unit 206 indicating a discharging status of the battery 208, controls the control unit 202 according to the second monitoring signal, and electrically isolates the discharging unit 206 from the control unit 202.

The first switch module 222 includes a transistor 230 and a relay 232. The relay 232 controls power to the charger 204. The transistor 230 is coupled to a control terminal of the relay 232, and controls the relay 232 based on the first control signal from the control unit 202. The charger 204 is powered by a power source 220 if the relay 232 is on. The second switch module 224 includes an isolator 234, e.g., an optical coupler or an iCoupler, and a relay 236. The relay 236 is controlled by the first monitoring signal from the charger 204. The isolator 234 is coupled between an output terminal of the relay 236 and the control unit 202, and electrically isolates the relay 236 from the control unit 202. The third switch module 226 includes a transistor 238 and a relay 240. The relay 240 controls whether the discharging unit 206 is enabled. The transistor 238 is coupled to a control terminal of the relay 240, and controls the relay 240 based on the second control signal from the control unit 202. The fourth switch module 228 includes an isolator 242, e.g., an optical coupler or an iCoupler, and a relay 244. The relay 244 is controlled by the second monitoring signal from the discharging unit 206. The isolator 242 is coupled between an output terminal of the relay 244 and the control unit 202, and electrically isolates the relay 244 from the control unit 202. By using the relays and isolators, the signals can be transferred between the control unit 202 and the charger 204, and between the control unit 202 and the discharging unit 206, without direct electrical connection.

In operation, if the battery testing system 200 is in the charging mode, the control unit 202 generates the first control signal with the first state (e.g., logic high) to turn on the transistor 230. As a result, the relay 232 is switched on by the transistor 230. The charger 204 is powered by the power source 220 and starts charging the battery 208. The relay 232 electrically isolates the charger 204 from the control unit 202. The first monitoring signal is in the first state if the capacity of the battery 208 is less than the predetermined capacity threshold. The charger 204 switches the first monitoring signal from the first state to the second state when the capacity of the battery 208 increases above the predetermined capacity threshold. In one embodiment, if the first monitoring signal is in the second state, the relay 236 is switched on. Thus, a current flows through an input side of the isolator 234, and an output side of the isolator 234 is turned on. The control unit 202 receives a logic low level signal which indicates that the capacity of the battery 208 is greater than the predetermined capacity threshold. However, in another embodiment, the first monitoring signal with the second state switches off the relay 236. As such, the control unit 202 receives a logic high level signal which indicates that the capacity of the battery 208 is greater than the predetermined capacity threshold. The relay 236 and the isolator 234 electrically isolate the charger 204 from the control unit 202. In response to the first monitoring signal with the second state which indicates that the capacity of the battery 208 is greater than the predetermined capacity threshold, the control unit 202 switches the first control signal from the first state (e.g., logic high) to the second state (e.g., logic low). As a result, the charger 204 is powered off to prevent a charging operation during a discharging process.

In one embodiment, the battery testing system 200 is configured to switch from the charging mode to the discharging mode if the capacity of the battery 208 is greater than the predetermined capacity threshold. More specifically, the control unit 202 switches the second control signal from the second state to the first state (e.g., logic high) once the control unit 202 switches the first control signal from the first state to the second state. The transistor 238 is turned on based on the second control signal with the first state. As a result, the relay 240 is switched on by the transistor 238. A discharging loop of the discharging unit 206 is conducted to enable the discharging unit 206 to discharge the battery 208. The relay 240 electrically isolates the discharging unit 206 from the control unit 202.

The second monitoring signal is in the first state if the voltage of the battery 208 is greater than the predetermined voltage threshold. The discharging unit 206 switches the second monitoring signal from the first state to the second state when the voltage of the battery 208 decreases below the predetermined voltage threshold. In one embodiment, if the second monitoring signal is in the second state, the relay 244 is switched on. Thus, a current flows through an input side of the isolator 242, and an output side of the isolator 242 is turned on. The control unit 202 receives a logic low level signal which indicates that the voltage of the battery 208 is less than the predetermined voltage threshold. However, in another embodiment, the second monitoring signal with the second state switches off the relay 244. As such, the control unit 202 receives a logic high level signal which indicates that the voltage of the battery 208 is less than the predetermined voltage threshold. The relay 244 and the isolator 242 electrically isolate the discharging unit 206 from the control unit 202. In response to the second monitoring signal with the second state which indicates that the voltage of the battery 208 is less than the predetermined voltage threshold, the control unit 202 switches the second control signal from the first state (e.g., logic high) to the second state (e.g., logic low). As a result, the discharging loop of the discharging unit 206 is cut off to prevent a discharging operation during the charging process. In one embodiment, the control unit 202 switches the first control signal from the second state to the first state once the control unit 202 switches the second control signal from the first state to the second state. Then, the next cycle begins and the battery 208 is charged again. Thus, the battery 208 is charged and discharged alternately, in one embodiment.

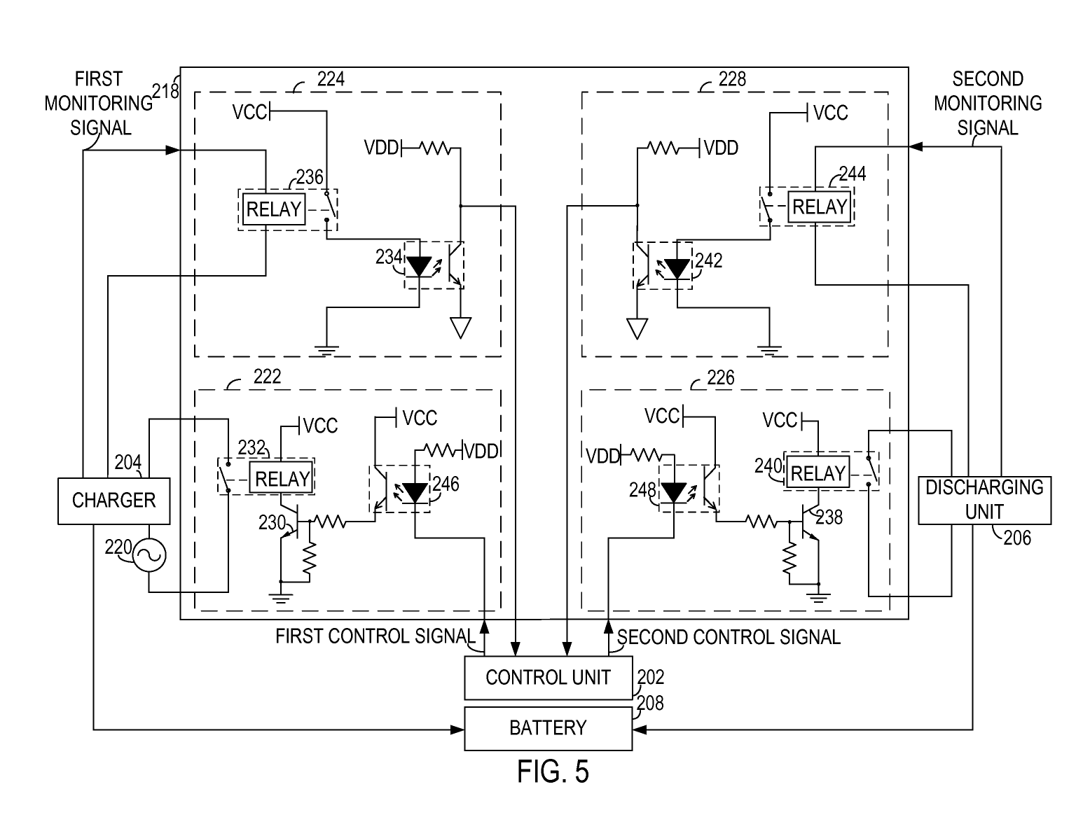

FIG. 5 illustrates another example of the switch board 218 in FIG. 2, in accordance with one embodiment of the present invention. Elements that are labeled the same as in FIG. 4 have similar functions. The first switch module 222 in FIG. 5 is similar to the first switch module 222 in FIG. 4 and further includes an isolator 246 coupled between the transistor 230 and the control unit 202. The isolator 246 is operable for electrically isolating the control unit 202 from the transistor 230. In one embodiment, the isolator 246 is an optical coupler. In another embodiment, the isolator 246 can be an iCoupler. The third switch module 226 in FIG. 5 is similar to the third switch module 226 in FIG. 4 and further includes an isolator 248 coupled between the transistor 238 and the control unit 202. The isolator 248 is operable for electrically isolating the control unit 202 from the transistor 238. In one embodiment, the isolator 248 is an optical coupler. In another embodiment, the isolator 248 can be an iCoupler.

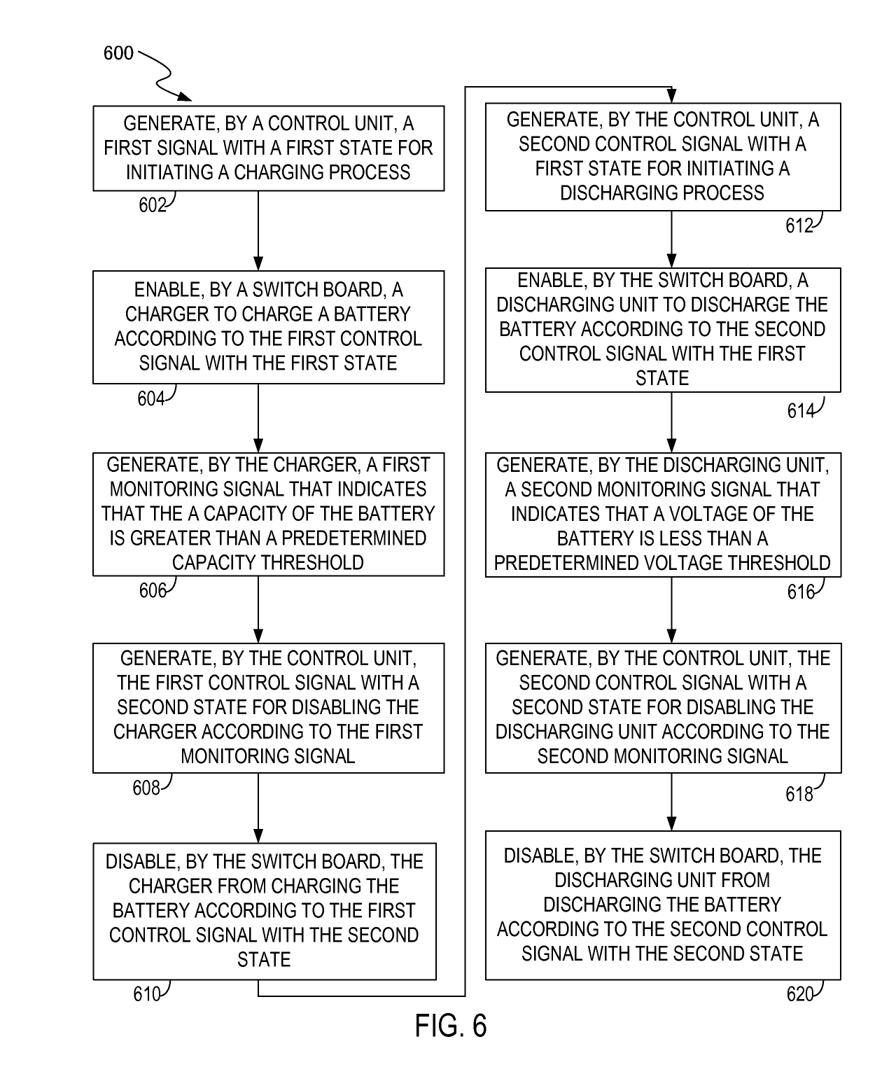

FIG. 6 illustrates a flowchart 600 of a method for controlling a battery testing system, in accordance with one embodiment of the present invention. FIG. 6 is described in combination with FIG. 2. In block 602, a first control signal with a first state is generated by a control unit, e.g., the control unit 202, for initiating a charging process. In block 604, a charger, e.g. the charger 204, is enabled to charge a battery by a switch board, e.g. the switch board 218, according to the first control signal with the first state. In block 606, a first monitoring signal indicating that a capacity of the battery is greater than a predetermined capacity threshold is generated by the charger 204. In block 608, a first control signal with a second state for disabling the charger 204 from charging the battery 208 is generated by the control unit 202 according to the first monitoring signal. In block 610, the charger 204 is disabled from charging the battery by the switch board 218 according to the first control signal with the second state.

In block 612, a second control signal with a first state is generated by the control unit 202 for initiating a discharging process. In block 614, a discharging unit, e.g., the discharging unit 206, is enabled to discharge the battery 208 by the switch board 218 according to the second control signal with the first state. In block 616, a second monitoring signal indicating that a voltage of the battery is less than a predetermined voltage threshold is generated by the discharging unit 206. In block 618, the second control signal with a second state for disabling the discharging unit 206 is generated by the control unit 202. In block 620, the discharging unit 206 is disabled from discharging the battery 208 by the switch board 218 according to the second control signal with the second state.

Accordingly, the present invention provides a battery testing system including a battery switch board which electrically isolates the control unit from the charger and discharging unit. Therefore, different charging/discharging equipments can be employed to test the battery.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A battery testing system comprising:
a charger that is operable for charging a battery under control of a control unit;
a discharging unit that is operable for discharging said battery under control of said control unit; and
a switch board that receives a first control signal from said control unit and controls said charger according to said first control signal, that receives a first monitoring signal from said charger indicating a charging status of said battery and controls said control unit according to said first monitoring signal, that receives a second control signal from said control unit and controls said discharging unit according to said second control signal, and that receives a second monitoring signal from said discharging unit indicating a discharging status of said battery and controls said control unit according to said second monitoring signal,
wherein said control unit is electrically isolated from said discharging unit and said charger by said switch board.

2. The battery testing system of claim 1, wherein said charger is operable for charging said battery independently if said charger is removed from said battery testing system.

3. The battery testing system of claim 1, wherein said first monitoring signal includes a first state indicating that a capacity of said battery is less than a predetermined capacity threshold, and a second state indicating that said capacity of said battery is greater than said predetermined capacity threshold, and
wherein said second monitoring signal includes a first state indicating that a voltage of said battery is greater than a predetermined voltage threshold, and a second state indicating that said voltage of said battery is less than said predetermined voltage threshold.

4. The battery testing system of claim 1, wherein said switch board comprises:
a first switch module that receives said first control signal from said control unit, that controls said charger according to said first control signal, and that electrically isolates said charger from said control unit;
a second switch module that receives said first monitoring signal from said charger, that controls said control unit according to said first monitoring signal, and that electrically isolates said charger from said control unit;
a third switch module that receives said second control signal from said control unit, that controls said discharging unit according to said second control signal, and that electrically isolates said discharging unit from said control unit; and
a fourth switch module that receives said second monitoring signal from said discharging unit, that controls said control unit according to said second monitoring signal, and that electrically isolates said discharging unit from said control unit.

5. The battery testing system of claim 4, wherein said first switch module comprises:
a relay that controls power to said charger; and
a transistor, coupled to a control terminal of said relay, that controls said relay based on said first control signal from said control unit.

6. The battery testing system of claim 4, wherein said second switch module comprises:
a relay that is controlled by said first monitoring signal from said charger; and
an optical coupler, coupled between an output terminal of said relay and said control unit, that electrically isolates said relay from said control unit.

7. The battery testing system of claim 4, wherein said third switch module comprises:
a relay that controls whether said discharging unit is enabled; and
a transistor, coupled to a control terminal of said relay, that controls said relay based on said second control signal from said control unit.

8. The battery testing system of claim 4, wherein said fourth switch module comprises:
a relay that is controlled by said second monitoring signal from said discharging unit; and
an optical coupler, coupled between an output terminal of said relay and said control unit, that electrically isolates said relay from said control unit.

9. The battery testing system of claim 5, wherein said first switch module further comprises an optical coupler, coupled between said transistor and said control unit, that electrically isolates said transistor from said control unit.

10. The battery testing system of claim 7, wherein said third switch module further comprises an optical coupler, coupled between said transistor and said control unit, that electrically isolates said transistor from said control unit.

11. The battery testing system of claim 1, wherein said discharging unit is disabled from discharging said battery based on said second control signal if said charger begins to charge said battery based on said first control signal, and
wherein said charger is disabled from charging said battery based on said first control signal if said discharging unit begins to discharge said battery based on said second control signal.

12. The battery testing system of claim 1, wherein said discharging unit comprises a cycling battery tester.

13. A battery testing system comprising:
a control unit that controls a charger for charging a battery, and that controls a discharging unit for discharging said battery; and
a switch board that receives a first control signal from said control unit and controls said charger according to said first control signal, that receives a first monitoring signal from said charger indicating a charging status of said battery and controls said control unit according to said first monitoring signal, that receives a second control signal from said control unit and controls said discharging unit according to said second control signal, and that receives a second monitoring signal from said discharging unit indicating a discharging status of said battery and controls said control unit according to said second monitoring signal,
wherein said control unit is electrically isolated from said discharging unit and said charger by said switch board.

14. The battery testing system of claim 13, wherein said switch board comprises:
a first switch module that receives said first control signal from said control unit, that controls said charger according to said first control signal, and that electrically isolates said charger from said control unit;
a second switch module that receives said first monitoring signal from said charger, that controls said control unit according to said first monitoring signal, and that electrically isolates said charger from said control unit;
a third switch module that receives said second control signal from said control unit, that controls said discharging unit according to said second control signal, and that electrically isolates said discharging unit from said control unit; and
a fourth switch module that receives said second monitoring signal from said discharging unit, that controls said control unit according to said second monitoring signal, and that electrically isolates said discharging unit from said control unit.

15. The battery testing system of claim 14, wherein said first switch module comprises:
a relay that controls power to said charger; and
a transistor, coupled to a control terminal of said relay, that controls said relay based on said first control signal from said control unit.

16. The battery testing system of claim 14, wherein said second switch module comprises:
a relay that is controlled by said first monitoring signal from said charger; and
an optical coupler, coupled between an output terminal of said relay and said control unit, that electrically isolates said relay from said control unit.

17. The battery testing system of claim 14, wherein said third switch module comprises:
a relay that controls whether said discharging unit is enabled; and
a transistor, coupled to a control terminal of said relay, that controls said relay based on said second control signal from said control unit.

18. The battery testing system of claim 14, wherein said fourth switch module comprises:
a relay that is controlled by said second monitoring signal from said discharging unit; and
an optical coupler, coupled between an output terminal of said relay and said control unit, that electrically isolates said relay from said control unit.

19. The battery testing system of claim 13, wherein said discharging unit is disabled from discharging said battery based on said second control signal if said charger begins to charge said battery based on said first control signal; and
wherein said charger is disabled from charging said battery based on said first control signal if said discharging unit begins to discharge said battery based on said second control signal.

20. A method for controlling a battery testing system, said method comprising:
generating, by a control unit, a first control signal with a first state for initiating a charging process;
enabling, by a switch board, a charger to charge a battery according to said first control signal with said first state;
generating, by said charger, a first monitoring signal that indicates that a capacity of said battery is greater than a predetermined capacity threshold;
generating, by said control unit, said first control signal with a second state for disabling said charger according to said first monitoring signal;
disabling, by said switch board, said charger from charging said battery according to said first control signal with said second state;
generating, by said control unit, a second control signal with a first state for initiating a discharging process;
enabling, by said switch board, a discharging unit to discharge said battery according to said second control signal with said first state;
generating, by said discharging unit, a second monitoring signal that indicates that a voltage of said battery is less than a predetermined voltage threshold;
generating, by said control unit, said second control signal with a second state for disabling said discharging unit according to said second monitoring signal; and
disabling, by said switch board, said discharging unit from discharging said battery according to said second control signal with said second state.
